(19) United States
(12) Patent Application Publication
(10) Pub. No.: US 2019/0278317 A1
(43) Pub. Date: Sep. 12, 2019

(54) INPUT DEVICE

(71) Applicant: Panasonic Intellectual Property Management Co., Ltd., Osaka-shi, Osaka (JP)

(72) Inventors: Ryo Nakae, Okayama (JP); Kenichi Matsumoto, Okayama (JP); Kojiro Yano, Okayama (JP)

(73) Assignee: Panasonic Intellectual Property Management Co., Ltd., Osaka-shi, Osaka (JP)

(21) Appl. No.: 16/463,058

(22) PCT Filed: Dec. 20, 2017
(86) PCT No.: PCT/JP2017/045649

§ 371 Date: May 22, 2019

(30) Foreign Application Priority Data
Feb. 13, 2017 (JP) 2017-024067
Jun. 2, 2017 (JP) 2017-109736

(51) Int. Cl. G05G 1/02; G05G 5/05

(52) U.S. Cl. CPC G05G 1/02; G06F 3/02; G05G 2505/00; G05G 5/05

(57) ABSTRACT

An input device according to the present disclosure includes: an elastic body; a pressing portion at a first end of the elastic body, which is capable of pressing the elastic body in a first direction from the first end toward a second end of the elastic body; and a pressure sensor at the second end of the elastic body, which detects, via the elastic body, a pressing force applied by the pressing portion. Furthermore, the elastic body is located between the pressing portion and the pressure sensor.

### TECHNICAL FIELD

The present disclosure relates to an input device that is used for input to various electronic devices.

### BACKGROUND ART

Hereinafter, a conventional input device will be described. A conventional input device includes a pressure sensor and an elastic body. The pressure sensor is disposed inside the elastic body. An inputter causes the elastic body to elastically deform, for example, by pinching or pulling the elastic body. The pressure sensor detects elastic deformation of the elastic body and outputs a signal corresponding to the elastic deformation. In this way, the conventional input device outputs an input signal according to the result of detection by the pressure sensor.

Known examples of prior art document information related to the present disclosure include Patent Literature (PTL) 1.

### CITATION LIST

### Patent Literature

PTL 1: Unexamined Japanese Patent Publication No. 2012-004129

### SUMMARY OF THE INVENTION

However, the conventional input device detects complex dynamic variations in the elastic body by the pressure sensor. Therefore, there are cases where the conventional input device is subject to erroneous detection, etc., and makes an output unintended by an inputter. In other words, the conventional input device is most prone to the occurrence of erroneous input by an operator and is difficult for a person who is unaccustomed to operating to make an appropriate input.

An input device according to the present disclosure includes: an elastic body; a pressing portion at a first end of the elastic body, which is capable of pressing the elastic body in a first direction from the first end toward a second end of the elastic body; and a pressure sensor at the second end of the elastic body, which detects, via the elastic body, a pressing force applied by the second pressing portion. Furthermore, the elastic body is located between the pressing portion and the pressure sensor.

In the input device according to the present disclosure, the pressure sensor is disposed opposite the pressing portion across the elastic body. Therefore, an operator can make an input to the input device by pressing the pressing portion. Thus, the input device according to the present disclosure is capable of detecting the input with a simple operation. Note that examples of the “simple operation” include “folding” and “pulling” in addition to “pressing”.

### BRIEF DESCRIPTION OF THE DRAWINGS

FIG. 1 is an exploded perspective view of an input device according to Embodiment 1.

FIG. 2 is a perspective view of an input device according to Embodiment 1.

FIG. 3A is a perspective view of an input device according to Embodiment 2.

FIG. 3B is a cross-sectional view of a housing of an input device according to Embodiment 2.

FIG. 4 is a perspective view of an input device according to the first variation.

FIG. 5 is a cross-sectional view of an input device according to the first variation.

FIG. 6 is a perspective view of an input device according to the second variation.

FIG. 7 is a cross-sectional view of an input device according to the second variation.

### DESCRIPTION OF EMBODIMENTS

Hereinafter, an input device according to the present embodiment will be described. Note that although the present disclosure is described using terms indicating directions such as “above/up”, “below/down”, “upper surface”, and “lower surface”, these merely indicate relative positioning and thus are not limiting.

### Embodiment 1

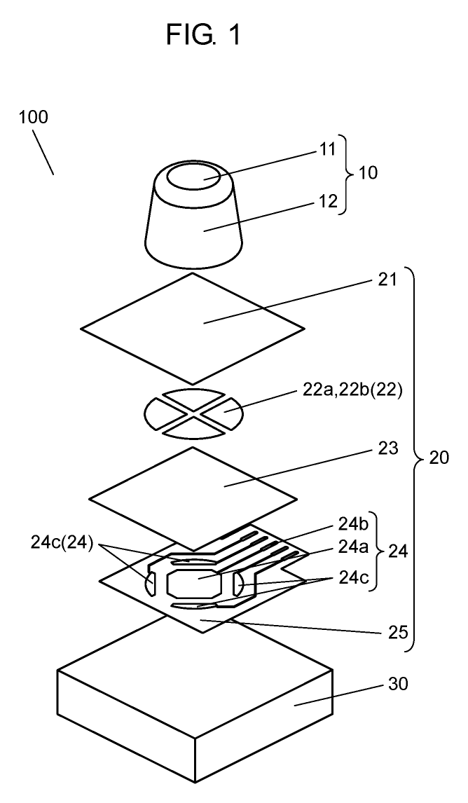

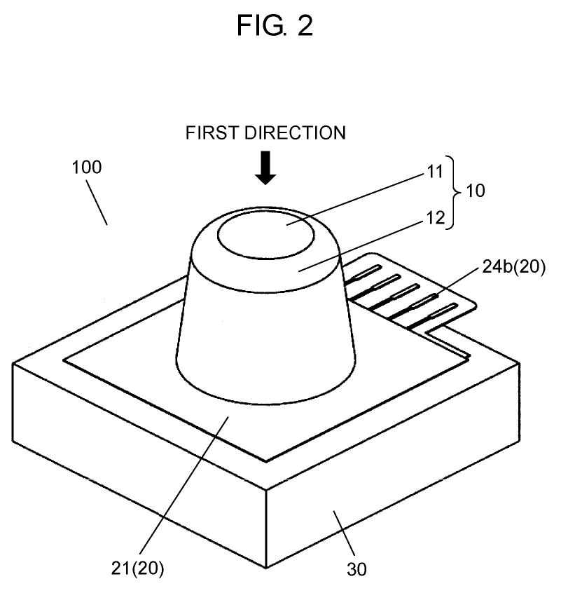

Input device 100 will be described with reference to FIG. 1 and FIG. 2. FIG. 1 is an exploded perspective view of input device 100. FIG. 2 is a perspective view of input device 100.

### [Configuration of Input Device 100]

Input device 100 includes input portion 10 and pressure sensor 20. Input portion 10 includes pressing portion 11 and elastic body 12. Pressing portion 11 is disposed above pressure sensor 20 so as to be able to press elastic body 12.

Pressure sensor 20 is located opposite pressing portion 11 across elastic body 12. In other words, elastic body 12 is sandwiched between pressure sensor 20 and pressing portion 11.

### [Operation of Input Device 100]

The operation of input device 100 configured as described above will be described. When an inputter (not illustrated in the drawings) presses pressing portion 11 in the first direction (indicated in FIG. 2), the pressing force applied by the inputter is transmitted to elastic body 12. Elastic body 12 elastically deforms with the pressing force. Pressing portion 11 that has elastically deformed tends to recover its original shape, and thus elastic body 12 exhibits resilience. However, the pressing force is greater than the resilience in the state where elastic body 12 is pressed. Therefore, the lower surface of elastic body 12 presses pressure sensor 20.

According to changes in electrical resistance, capacitance, and the like, pressure sensor 20 detects the pressing force applied by elastic body 12. Subsequently, input device 100 outputs a signal to the outside via wired or wireless connection on the basis of the result of detection by pressure sensor 20. As another example, input device 100 may output sound, light, vibration, or the like on the basis of the result of detection by pressure sensor 20. Furthermore, input device 100 may change the output sound, light, vibration, or the like.

In input device 100, in order to operate as described above, the direction of the force of the pressure detected by pressure sensor 20 is oriented from the upper surface (first end) of elastic body 12 on which pressing portion 11 is disposed toward the lower surface (second end) of elastic body 12. In other words, in the present embodiment, the direction in which elastic body 12 is pressed is the first direction indicated in FIG. 2, and the direction of the pressure detected by pressure sensor 20 is the first direction.

Pressure sensor 20 is capable of detecting a force component from the lower surface (second end) of elastic body 12 via elastic body 12. Therefore, it is possible to make an input to input device 100 with a simple operation of just pressing. Furthermore, an inputter is not required to perform a complex operation such as “pinching” elastic body 12 to make an input to input device 100. Moreover, input device 100 according to the present embodiment does not require a “pulling” operation. Therefore, input device 100 has improved durability. In addition, since elastic body 12 is disposed between pressing portion 11 and pressure sensor 20, there is no need for an inputter to directly press pressure sensor 20 which is hard in terms of kinesthetic sense. Thus, it is possible to reduce the force of an inputter making an input to input device 100.

Note that pressing portion 11 and elastic body 12 may be integrally formed or may be separately formed. For example, in the case where pressing portion 11 and elastic body 12 are integrally formed, the pressing surface of elastic body 12 or an end of elastic body 12 such as a pressing protrusion corresponds to pressing portion 11. As a result of pressing portion 11 and elastic body 12 being integrally formed, an inputter can feel the touch of elastic body 12 when making an input.

Note that pressing portion 11 and elastic body 12 may be separately formed in such a manner that allows pressing portion 11 to press elastic body 12 via a mechanical mechanism, a spring, a metal plate, or the like. In this case, the mechanical mechanism, the spring, and the metal plate may each be part of pressing portion 11.

Pressing portion 11 may include a mechanical mechanism, a spring, a metal plate, or the like. With this, it is possible to keep an inputter from pressing a wrong point, and thus input device 100 can operate more reliably.

### [Detailed Configuration of Input Device 100]

Input device 100 will be described in more detail below, assuming that the pressing portion 11 side of elastic body 12 is the upper side and the pressure sensor 20 side of elastic body 12 is the lower side.

Input device 100 includes: input portion 10 including pressing portion 11 and elastic body 12; pressure sensor 20 disposed opposite pressing portion 11 across elastic body 12; and base plate 30 to which pressure sensor 20 is fixed.

Note that the upper surface of base plate 30 may be flat or may include a recess. In the case where the upper surface of base plate 30 includes a recess, sheet 21 is disposed in the recess of base plate 30.

Input portion 10 is disposed on pressure sensor 20 by being, for example, fixed to pressure sensor 20 with screws, mechanically held on pressure sensor 20, or adhered or bonded to pressure sensor 20.

Note that pressing portion 11 and elastic body 12 may be integrally formed. In other words, in the case where pressing portion 11 and elastic body 12 are integrally formed, the pressing surface (end) of elastic body 12 serves as pressing portion 11.

The shape of pressing portion 11 is not particularly limited. For example, pressing portion 11 may be in the form of a protrusion or may have more than one surface.

Elastic body 12 is, for example, formed from an elastomer which is thermosetting rubber. The elastomer is very flexible. More specifically, the elastomer can be formed into a predetermined shape by shaping a material containing silicon by reaction injection molding (RIM), for example.

Elastic body 12 is in a frustum shape. Note that elastic body 12 may be opaque or may be transparent. The shape of elastic body 12 may be, for example, is a cone form such as a cone, a triangular pyramid, and a quadrangular pyramid. Alternatively, the shape of elastic body 12 may be, for example, a columnar form such as a circular cylinder, a triangular prism, and a quadrangular prism. Yet alternatively, the shape of elastic body 12 may be, for example, a polyhedron such as a tetrahedron and an octahedron.

As described above, elastic body 12 is formed in various shapes. In particular, elastic body 12 is preferably in a frustum shape such as a truncated cone, a truncated triangular pyramid, and a truncated quadrangular pyramid. In other words, elastic body 12 is preferably shaped to be wider on the lower surface (second surface) than on the upper surface (first surface). In addition, elastic body 12 is more preferably disposed in such a manner as to gradually expand downward from the top. As a result of being disposed in such a manner as to gradually expand downward from the top, elastic body 12 can evenly spread and transmit the pressing force applied to pressing portion 11 to electrically conductive portion 22 of pressure sensor 20, allowing a reduction in force that is applied to pressure sensor 20.

Pressure sensor 20 includes insulating sheet 21, electrically conductive portion 22, dielectric portion 23, electrode portion 24, and base sheet 25.

Insulating sheet 21 is formed of a single sheet obtained by processing an insulating polymer material in the form of a film, for example. Electrically conductive portion 22 is disposed below sheet 21.

Electrically conductive portion 22 includes four pillar structures 22a and pillar electrodes 22b. Each of four pillar structures 22a is electrically connected to corresponding pillar electrode 22b. Pillar structure 22a is in the form of a sheet having a side on which a large number of protrusions are formed. Pillar structure 22a is disposed so that the protrusions face down. Stated differently, assuming that pillar structure 22a has a front side which is smooth and a back side on which the protrusions are formed, for example, pillar structure 22a is disposed so that the side on which the protrusions are formed faces down while the side which is smooth faces up. Note that pillar structure 22a may have front and back sides on both of which protrusions are formed. Pillar electrode 22b is electrically connected to the upper side of pillar structure 22a. Pillar electrode 22b is formed on pillar structure 22a by depositing, sputtering, etc., an electrically conductive metal material, for example.

Dielectric portion 23 is disposed below electrically conductive portion 22. In other words, electrically conductive portion 22 is sandwiched between sheet 21 and dielectric portion 23. Dielectric portion 23 is, for example, a film formed from a dielectric material such as polyimide (PD.

Electrode portion 24 is disposed below dielectric portion 23. Electrode portion 24 includes one input electrode 24a, four output electrodes 24c, and five routing electrodes 24b. Each of one input electrode 24a and four output electrodes 24c is electrically connected to corresponding routing electrode 24b among five routing electrodes 24b.

A detection electrode including input electrode 24a and output electrodes 24c is formed, for example, from gold, silver, copper, or the like. Furthermore, routing electrodes 24b are also formed from gold, silver, copper, or the like. Input electrode 24a and output electrodes 24c are disposed below elastic body 12.

Four output electrodes 24c are disposed at equal intervals, each in one of four segments separated by a first straight line which passes through the center of the bottom surface of elastic body 12 in the form of a truncated cone and a second straight line which passes through the center of the bottom surface of elastic body 12 in the form of a truncated cone and perpendicularly crosses the first straight line.

Each of output electrodes 24c is disposed opposite corresponding pillar electrode 22b across dielectric portion 23. Electrode portion 24 is disposed on base sheet 25.

Base sheet 25 is a film formed from polyethylene terephthalate (PET). Electrode portion 24 is formed on the front side of base sheet 25 by screen printing or sputtering. Base sheet 25 is disposed below dielectric portion 23 and is disposed on base plate 30 so that the front side on which electrode portion 24 is formed faces up. Electrode portion 24 is disposed sandwiched between base sheet 25 and dielectric portion 23.

Pressure sensor 20 including sheet 21, electrically conductive portion 22, dielectric portion 23, electrode portion 24, and base sheet 25 is fixed to base plate 30.

Note that although one sheet 21 is provided in the present embodiment, separate sheets 21 may be formed for four pillar structures 22a, respectively. Specifically, four sheets 21 may be disposed above pillar structures 22a in such a manner that above each of pillar structures 22a is located corresponding sheet 21 among four sheets 21.

The same as sheet 21 applies to dielectric portion 23; four dielectric portions 23 may be disposed below four pillar structures 22a in such a manner that separate dielectric portions 23 are located below respective pillar structures 22a. In other words, below each of pillar structures 22a may be disposed corresponding dielectric portion 23.

Base plate 30 is formed from an acrylic resin, for example. Base plate 30 is disposed below pressure sensor 20. Base plate 30 and pressure sensor 20 are bonded together, for example, with an adhesive or the like.

### [Detailed Operation of Input Device 100]

As a result of pressing portion 11 being pressed, input device 100 configured as described above operates as follows.

When pressing portion 11 is pressed, the pressing force is transmitted to sheet 21 via elastic body 12. This causes bending of sheet 21. The bending of sheet 21 causes electrically conductive portion 22 to elastically deform. This means that electrically conductive portion 22 is pressed via sheet 21.

Pillar electrode 22b of electrically conductive portion 22 is electrically connected to a power supply such as a battery, for example, and a voltage is applied to pillar structure 22a. Routing electrode 24b is electrically connected to the power supply. As a result, the voltage is applied to pillar structure 22a.

Dielectric portion 23 is disposed between electrically conductive portion 22 and electrode portion 24. As a result, there is capacitance storage between electrically conductive portion 22 and electrode portion 24. This capacitance changes as a result of a pressing force being applied to electrically conductive portion 22. Furthermore, this capacitance changes with respect to the pressing force, for example, based on a relationship such as a proportional, exponential, or stepwise manner.

This change in capacitance is detected by, for example, a control portion such as a microcontroller unit connected to a comparation device such as a comparator. When the change in capacitance is detected, the applied pressing force can be determined. Note that in this case, the relationship between the pressing force and the capacitance may be recorded as a table in a determination unit or may be recorded as a calculation formula in the determination unit.

Base sheet 25 on which electrode portion 24 is dispoed is fixed to base plate 30. Since base plate 30 is a hard plate having a sufficient level of rigidity against bending, it is less likely that the applied pressing force is reduced between elastic body 12 and pressure sensor 20. Thus, with this configuration, pressure sensor 20 is capable of detecting the pressing force more accurately.

Therefore, for example, using the microcontroller unit, the distribution of capacitance between dielectric portion 23 and four electrode portions 24 is checked, and thus input device 100 can output the distribution of pressure. The output of input device 100 may be sound, light, vibration, or the like. Furthermore, input device 100 may output those to the outside via wired or wireless connection.

With this, input device 100 can make an input with respect to three axes including an x-axis, a y-axis orthogonal to the x-axis, and a z-axis orthogonal to an x-y plane defined by the x-axis and the y-axis. Thus, an inputter can make an input with a simple operation such as folding pressing portion 11 forward/backward/leftward/rightward and pressing or pulling pressing portion 11, for example.

Note that in the case where only the pressing operation by inputters is intended, pressure sensor 20 is not required to include four detection electrodes unlike the present embodiment. For example, pressure sensor 20 including one detection electrode may be disposed below elastic body 12 of input portion 10. Even when pressure sensor 20 includes only one detection electrode as just mentioned, pressure sensor 20 can detect the pressing force.

Note that in the present disclosure, one set of input electrode 24a and one output electrode 24c is described as one detection electrode.

Furthermore, since input device 100 is configured so that pressure sensor 20 is pressed via elastic body 12 which is very flexible, the range of pressure detectable by pressure sensor 20 can be set wider than, for example, in the case where force is applied directly to pressure sensor 20 and in the case where pressure sensor 20 is pressed using a hard material. In other words, the pressure detection range of pressure sensor 20 is wide.

Moreover, input device 100 can be used as a sensor.

For example, a target to be sensed is disposed above input portion 10. According to an operation of the target to be sensed, elastic body 12 vibrates or the center of gravity of elastic body 12 moves, for example. This change is detected by, for example, four detection electrodes, and thus the gradient/vibration/weight of a detection target can be monitored. Furthermore, when input device 100 is connected to a balance device via wired or wireless connection, input device 100 can input the detection result to the balance device to adjust the balance of the detection target.

Furthermore, in the case of making a pulling input operation available for input device 100, elastic body 12 may be disposed in a manner that keeps pressure sensor 20 pressed. One example of such a configuration is as follows.

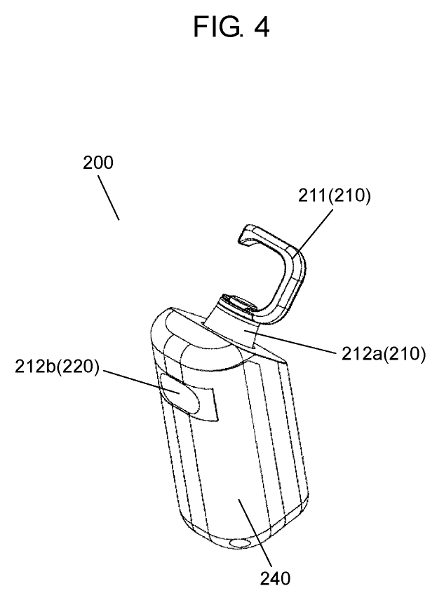

As illustrated in FIG. 4, housing 240 allows elastic body 212a to be held pressed against the pressure sensor (not illustrated in the drawing) in an exemplary configuration. As a result, input device 200 is capable of accurately detecting a pulling operation (an operation that reduces the pressure on pressure sensor 20) which is opposite to pressing. Note that the detailed configuration of input device 200 illustrated in FIG. 4 will be described later as the first variation.

### Embodiment 2

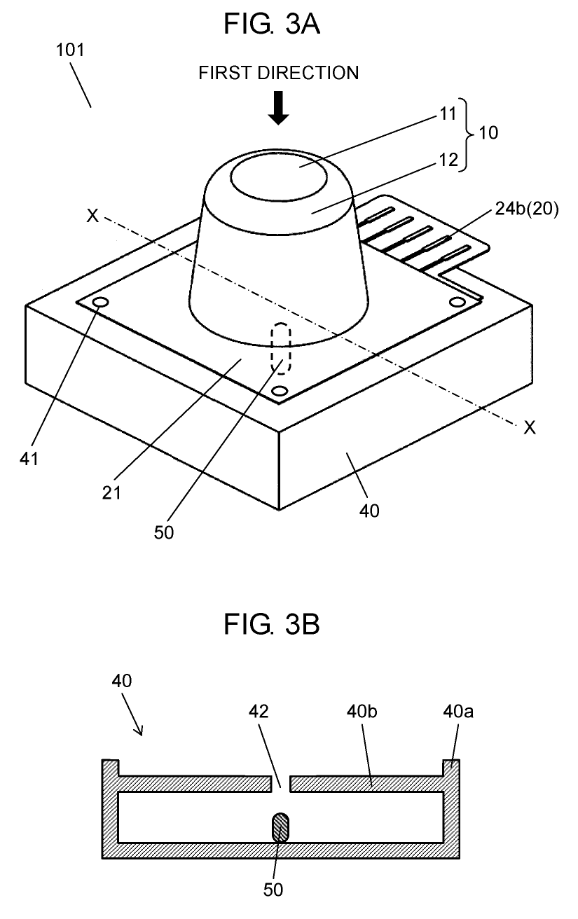

Next, input device 101 according to Embodiment 2 will be described with reference to FIG. 3A and FIG. 3B. FIG. 3A is a perspective view of input device 101 according to Embodiment 2. FIG. 3B is a cross-sectional view of housing 40 of input device 101 according to Embodiment 2. Note that FIG. 3B is a cross-sectional view of housing 40 taken along line X-X indicated in FIG. 3A.

Input device 100 described with reference to FIG. 2 and input device 101 illustrated in FIG. 3A and FIG. 3B are different in that base plate 30 is replaced by housing 40 and in that light-emitting diode 50 is disposed inside housing 40. Light-emitting diode 50 is connected to electrode portion 24 via a control portion (not illustrated in the drawings). Note that the other elements are the same as or similar to those in Embodiment 1 described with reference to FIG. 1 and FIG. 2; thus, the same or similar elements are assigned the same reference marks, and as such, detailed description thereof will be omitted.

Housing 40 is formed, for example, from a resin material such as an acrylic resin or an inorganic material such as glass. As in input device 100, input portion 10 and pressure sensor 20 are disposed above housing 40.

Housing 40 includes, at four corners, four fixing portions 41 which fix pressure sensor 20. Pressure sensor 20 includes, at four corners of base sheet 25 and at four corners of sheet 21, holes corresponding to the fixing portions. Fixing portions 41 protrude upward and pass through the holes of pressure sensor 20, thereby fixing pressure sensor 20.

As illustrated in FIG. 3B, housing 40 includes, along electrode portion 24 of pressure sensor 20, protrusion 40a which protrudes upward. In housing 40, protrusion 40a produces a difference in level between lower surface 40b and protrusion 40a. Housing 40 includes a recess formed by lower surface 40b and protrusion 40a. Pressure sensor 20 is disposed in the recess. Lower surface 40b has, in a position corresponding to a central area of electrode portion 24, through-hole 42 connecting the recess and the inside of housing 40. Housing 40 includes a space below lower surface 40b. Light-emitting diode 50 is disposed in this space, in a position facing through-hole 42. Light from light-emitting diode 50 is directed to through-hole 42. The light-emitting diode disposed in the space in housing 40 has a light emission surface facing through-hole 42. Light-emitting diode 50 is capable of changing the intensity, color, or the like of light, for example, according to the pressure detected by pressure sensor 20. Light-emitting diode 50 may emit light of three colors, i.e., red, green, and blue light. Light-emitting diode 50 may emit light of three or more colors by combining light of three colors, i.e., red, green, and blue light. Light-emitting diode 50 may emit light of a single color only.

The operation of input device 101 configured as described above will be described.

Input device 101 detects, by pressure sensor 20, the pressing force applied to input portion 10. The control portion determines the level of the pressure detected by pressure sensor 20. The control portion outputs a control signal to light-emitting diode 50 on the basis of the determination result. Light-emitting diode 50 is capable of changing the intensity, color, or the like of light, for example, on the basis of the control signal.

Here, one example of a method for changing the intensity of light and one example of a method for changing the color of light will be described. In the case of changing the intensity of light, for example, light-emitting diode 50 that emits red light is continuously or intermittently turned ON to emit bright light, in accordance with the pressing force applied to input portion 10. In the case of changing the color of light, for example, light-emitting diode 50 that emits white light in the state where no pressure is applied is continuously or intermittently turned ON to emit blue, green, and red light in turns, in accordance with the pressing force applied to input portion 10.

In addition, the light from light-emitting diode 50 may cause transparent housing 40 to glow or may pass through pressure sensor 20 to cause input portion 10 to glow.

Because of operating in this way, input device 101 can provide a direct input and a direct change to an inputter. This means that in the present embodiment, an inputter can visually grasp a situation. Thus, in the case where input device 101 is used in an entertainment device such as a gaming or virtual reality device, the entertainment device can feed back to an inputter a light stimulus corresponding to the type of action while allowing for an action in a three-dimensional space. With this, an inputter can be given a stronger feeling of reality when making an input.

### First Variation

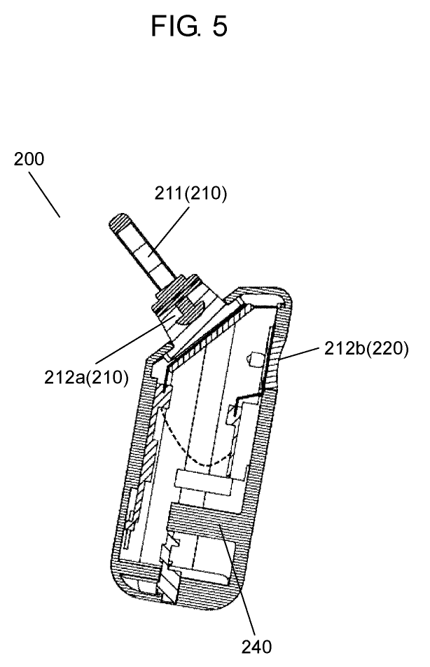

Next, with reference to FIG. 4 and FIG. 5, an application example of input device 100 (or input device 101) described above will be described as the first variation. Input device 200 illustrated in FIG. 4 and FIG. 5 includes first input portion 210, second input portion 220, and housing 240.

First input portion 210 includes elastic body 212a, hook portion 211, and a first pressure sensor portion (not illustrated in the drawings). Note that the first pressure sensor portion has substantially the same configuration as, for example, pressure sensor 20 (refer to FIG. 1, etc.) according to the exemplary embodiments described above. Elastic body 212a is formed from an elastomer as in the exemplary embodiments described above. Hook portion 211 is mechanically connected to elastic body 212a. Hook portion 211 is, for example, obtained by forming a plastic material, a metal material, or the like into a hook shape. The first pressure sensor portion is disposed, for example, below elastic body 212a so as to be able to detect the distribution of pressure in elastic body 212a. In other words, first input portion 210 is configured to be able to make an input with respect to the three axes (x-axis, y-axis, z-axis).

Second input portion 220 includes elastic body 212b and a second pressure sensor portion (not illustrated in the drawings). Note that the second pressure sensor portion has substantially the same configuration as, for example, pressure sensor 20 (refer to FIG. 1, etc.) according to the exemplary embodiments described above. Elastic body 212b is formed from an elastomer as in the exemplary embodiments described above. The second pressure sensor portion is disposed, for example, below elastic body 212b so as to be able to detect the distribution of pressure in elastic body 212b.

Housing 240 holds elastic body 212a in such a manner that elastic body 212a is pushed against the first pressure sensor portion. For example, housing 240 is formed from a plastic material, a metal material, or the like. A control portion which is electrically connected to the first pressure sensor portion and the second pressure sensor portion is disposed in housing 240. Furthermore, for example, a communication portion which is electrically connected to the control portion is disposed in housing 240.

Input device 200 is configured so that hook portion 211 can be pulled. In the state where hook portion 211 is not pulled, the first pressure sensor portion is pressed against elastic body 212a. In other words, in the state where an operator has performed no operation (in the state prior to pressing or pulling), the first pressure sensor portion detects a predetermined pressure. With this configuration, first input portion 210 can make inputs by both the pressing operation and the operation of pulling hook portion 211.

Furthermore, input device 200 includes second input portion 220. Because of including two input portions, input device 200 according to the present embodiment is capable of composite input using first input portion 210 and second input portion 220. It is also possible to allocate different operations to first input portion 210 and second input portion 220.

Housing 240 of input device 200 is formed having an elongated shape so as to fit to the shape of a hand and thus can be easily operated with one hand. An operator can make an input to input device 200, for example, by gripping second input portion 220. In addition, an operator can make an input to input device 200, for example, by tilting, pressing, or pulling first input portion 210.

Note that each of the first pressure sensor portion and the second pressure sensor portion may be formed using a pressure sensor such as pressure sensor 20 according to Embodiment 1. Furthermore, the position of the first pressure sensor portion relative to elastic body 212a and the position of the second pressure sensor relative to elastic body 212b may be the same as or similar to those in Embodiment 1.

Furthermore, in the case where elastic body 212a has a mass such that the pressure can be detected by the first pressure sensor portion, housing 240 is not required to push elastic body 212a against the first pressure sensor portion.

### Second Variation

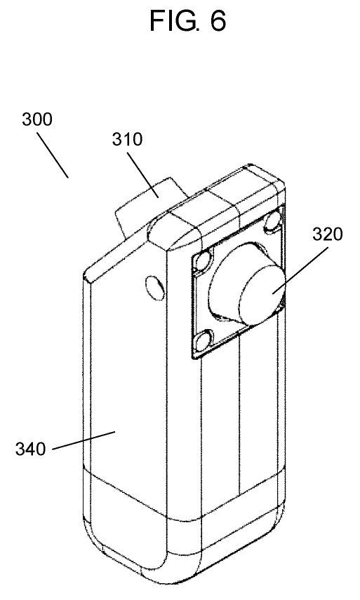

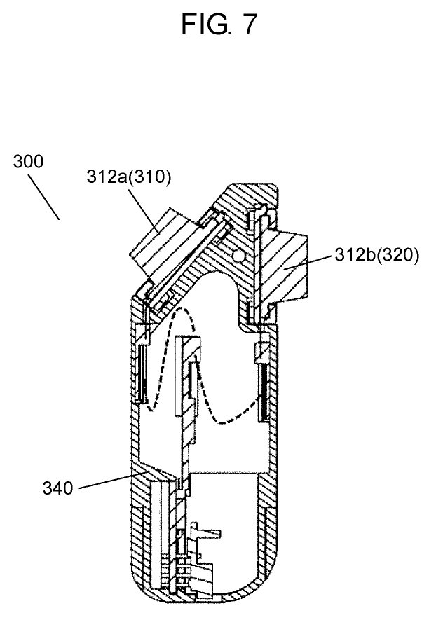

Next, with reference to FIG. 6 and FIG. 7, an application example of input device 100 (or input device 101) described above will be described as the second variation. Input device 300 includes first input portion 310, second input portion 320, and housing 340. Input device 300 is configured so that both first input portion 310 and second input portion 320 are capable of making inputs with respect to the three axes.

First input portion 310 includes elastic body 312a and a first pressure sensor portion (not illustrated in the drawings). Note that the first pressure sensor portion has substantially the same configuration as, for example, pressure sensor 20 (refer to FIG. 1, etc.) according to the exemplary embodiments described above. Elastic body 312a is formed from an elastomer as in the exemplary embodiments described above. The first pressure sensor portion is disposed, for example, below elastic body 312a so as to be able to detect the distribution of pressure in elastic body 312a.

Second input portion 320 includes elastic body 312b and a second pressure sensor portion (not illustrated in the drawings). As with the first pressure sensor portion, the second pressure sensor portion also has substantially the same configuration as, for example, pressure sensor 20 (refer to FIG. 1, etc.) according to the exemplary embodiments described above. Elastic body 312b is also formed from an elastomer, as with elastic body 312a. The second pressure sensor portion is disposed, for example, below elastic body 312b so as to be able to detect the distribution of pressure in elastic body 312b.

Housing 340 holds first input portion 310 and second input portion 320. For example, housing 340 is formed from a plastic material, a metal material, or the like. A control portion which is electrically connected to the first pressure sensor portion and the second pressure sensor portion and a communication portion which is electrically connected to the control portion are, for example, disposed in housing 340.

In input device 300, each of first input portion 310 and second input portion 320 is capable of making an input with respect to the three axes. Therefore, input device 300 is capable of operating a moving body by first input portion 310 and operating, by second input portion 320, a camera or the like disposed on the moving body. The moving body herein is, for example, a radio-controller car or a drone.

Note that a hook portion such as hook portion 211 illustrated in FIG. 4 may be provided on elastic body 312a, elastic body 312b, or the like. Furthermore, elastic body 312a may be pushed against the first pressure sensor portion. Moreover, elastic body 312b may be pushed against the second pressure sensor portion.

As described above, two or more input devices may be disposed on one housing.

Note that in input device 100 according to Embodiment 1, pressure sensor 20 is bonded to base plate 30, but may be fixed thereto by fixing portion 41 (refer to FIG. 3A) as in Embodiment 2.

Inversely, although pressure sensor 20 is fixed to housing 40 using fixing portion 41 in input device 101 according to Embodiment 2, this may be replaced by bonding as in Embodiment 1.

### (Closing)

The input device according to the present disclosure includes elastic body 12, pressing portion 11, and pressure sensor 20. Pressing portion 11 is disposed at one end of elastic body 12 and presses elastic body 12 in a first direction from the one end toward the other end. Pressure sensor 20 is disposed at the other end of elastic body 12 and detects, via elastic body 12, the pressing force applied by pressing portion 11. Elastic body 12 is located between pressing portion 11 and pressure sensor 20.

In the input device according to the present disclosure, elastic body 12 and pressing portion 11 may be integrally formed. At this time, one end of elastic body 12 may be pressing portion 11.

In the input device according to the present disclosure, elastic body 12 may be in a frustum shape having a first surface and a second surface larger than the first surface. Pressing portion 11 is disposed on the first surface, and pressure sensor 20 is disposed on the second surface.

Furthermore, the input device according to the present disclosure may further includes at least one of sheet 21, housing 40, and the like on which pressure sensor 20 is disposed.

### INDUSTRIAL APPLICABILITY

The input device according to the present disclosure has the advantageous effect of enabling an intuitive input and is useful in various electronic devices and the like.

### REFERENCE MARKS IN THE DRAWINGS

10 input portion
11 pressing portion
12 elastic body
20 pressure sensor
21 sheet
22 electrically conductive portion
22a pillar structure
22b pillar electrode
23 dielectric portion
24 electrode portion
24a input electrode
24b routing electrode
24c output electrode
25 base sheet
30 base plate
40 housing
40a protrusion
40b lower surface
41 fixing portion
42 through-hole
50 light-emitting diode
100, 101, 200 input device
210 first input portion
211 hook portion
212a, 212b elastic body
220 second input portion
240 housing
300 input device
310 first input portion
312a, 312b elastic body
320 second input portion
340 housing

1. An input device comprising:
an elastic body;
a pressing portion at a first end of the elastic body, the pressing portion being capable of pressing the elastic body in a first direction from the first end toward a second end of the elastic body; and
a pressure sensor at the second end of the elastic body, the pressure sensor detecting, via the elastic body, a pressing force applied by the pressing portion, wherein
the elastic body is located between the pressing portion and the pressure sensor.

2. The input device according to claim 1, wherein
the elastic body and the pressing portion are integrally formed.

3. The input device according to claim 2, wherein
the first end of the elastic body is the pressing portion.

4. The input device according to claim 1, wherein
the elastic body is in a frustum shape having a first surface and a second surface larger than the first surface,
the pressing portion is disposed on the first surface, and
the pressure sensor is disposed on the second surface.

5. The input device according to claim 1, further comprising:
at least one of a sheet and a housing on which the pressure sensor is disposed.
